(19) United States
(12) Patent Application Publication
(10) Pub. No.: US 2017/0090202 A1
(43) Pub. Date: Mar. 30, 2017

(54) WEARABLE DEVICE

(71) Applicant: OLYMPUS CORPORATION, Tokyo (JP)

(72) Inventor: Seiji TATSUTA, Tokyo (JP)

(73) Assignee: OLYMPUS CORPORATION, Tokyo (JP)

(21) Appl. No.: 15/278,137

(22) Filed: Sep. 28, 2016

(30) Foreign Application Priority Data
Sep. 30, 2015 (JP) 2015-193705

(51) Int. Cl. G02B 27/01; G06F 3/01

(52) U.S. Cl. CPC G02B 27/0176; G06F 3/011; G02B 2027/0159; G02B 2027/0161; G02B 2027/0178

(57) ABSTRACT

A wearable device includes a wearable element that is worn on the head, a connector that is connected to the wearable element so as to be rotatable around a first rotation axis, and a display that is connected to the connector so as to be rotatable around a second rotation axis. The relationship “20 mm≦L1+L2≦45 mm” is satisfied provided that a virtual plane includes an eyepiece optical axis of the display and intersects the first rotation axis and the second rotation axis, L1 is the distance from a first intersection that is the intersection of the virtual plane and the first rotation axis to a second intersection that is the intersection of the virtual plane and the second rotation axis, and L2 is the distance from the second intersection to an intersection of an eyepiece and the eyepiece optical axis.

Japanese Patent Application No. 2015-193705 filed on Sep. 30, 2015, is hereby incorporated by reference in its entirety.

### BACKGROUND

The present invention relates to a wearable device and the like.

A wearable device (head-mounted display) that is worn on the head of the user and projects an image within the field of view of the user is known. For example, JP-A-2004-236242, JP-A-2001-108935, and JP-A-2006-3879 disclose technology that relates to such a wearable device.

JP-A-2004-236242 discloses a configuration in which a support arm is attached to an ear pad (sound output section) of a headphone through a hinge, and the support arm supports an image output section. The image output section can be moved from the side (or the upper side) to the front side of the face by rotating the support arm through the hinge JP-A-2001-108935 discloses a configuration in which an arm is attached to a head band through a ball and a ball bearing, and a viewer is attached to the arm through a hinge The arm can be rotated in an arbitrary direction by utilizing the ball and the ball bearing, and the viewer can be rotated around an approximately vertical axis by utilizing the hinge.

JP-A-2006-3879 discloses a pupil-division see-through-type head-mounted display. The technology disclosed in JP-A-2006-3879 significantly reduces the size of an eyepiece element (eyepiece window) that projects (emits) a virtual image of a display image to implement see-through display (i.e., display in which the external field of view and the display image overlap each other), and see-around display (i.e., display in which a wide external field of view is provided).

### SUMMARY

### According to one aspect of the invention, there is provided a wearable device comprising:

a wearable element that is worn on a head of a wearer;

a connector that is connected to the wearable element so as to be rotatable around a first rotation axis; and

a display that is connected to the connector so as to be rotatable around a second rotation axis, and displays a virtual image within part of a field of view of the wearer,

wherein a relationship “20 mm≦L1+L2≦45 mm” is satisfied provided that a plane that includes an eyepiece optical axis of the display and intersects the first rotation axis and the second rotation axis is referred to as a virtual plane, a distance from a first intersection that is an intersection of the virtual plane and the first rotation axis to a second intersection that is an intersection of the virtual plane and the second rotation axis is referred to as L1, and a distance from the second intersection to an intersection of an eyepiece and the eyepiece optical axis is referred to as L2.

According to another aspect of the invention, there is provided a wearable device comprising:

a wearable element that is worn on a head of a wearer;

a connector that is connected to the wearable element so as to be rotatable around a first rotation axis; and

a display that is connected to the connector so as to be rotatable around a second rotation axis, and displays a virtual image within part of a field of view of the wearer,

wherein the first rotation axis passes through an eyeball of the wearer when the wearable element is worn on the head, and

a relationship “L1≧5×L2” is satisfied provided that a plane that includes an eyepiece optical axis of the display and intersects the first rotation axis and the second rotation axis is referred to as a virtual plane, a distance from a first intersection that is an intersection of the virtual plane and the first rotation axis to a second intersection that is an intersection of the virtual plane and the second rotation axis is referred to as L1, and a distance from the second intersection to an intersection of an eyepiece and the eyepiece optical axis is referred to as L2.

According to another aspect of the invention, there is provided a wearable device comprising:

a wearable element that is worn on a head of a wearer; and

a display that displays a virtual image within part of a field of view of the wearer,

wherein the display is connected to the wearable element so as to be rotatable around a rotation axis that is orthogonal to a virtual plane that is a plane that includes an eyepiece optical axis of the display, and

a condition “L2≧5 mm” is satisfied provided that a distance from an intersection of the rotation axis and the virtual plane to an intersection of an eyepiece and the eyepiece optical axis is referred to as L2.

### BRIEF DESCRIPTION OF THE DRAWINGS

FIG. 1 illustrates a configuration example of a wearable device according to one embodiment of the invention.

FIG. 2 illustrates a configuration example of a wearable device according to one embodiment of the invention.

FIG. 3 illustrates a configuration example of a wearable device according to a modification of one embodiment of the invention.

FIG. 4 is a schematic view illustrating the way in which a virtual image is viewed through an eyepiece window.

FIGS. 5A and 5B are schematic views illustrating the way in which a virtual image is viewed through an eyepiece window.

FIG. 6 is a schematic view illustrating the positions of a first rotation axis, a second rotation axis, an eyeball, and a display when a wearer wears a wearable device.

FIG. 7 is a view illustrating a display position adjustment and an alignment adjustment.

FIG. 8 is a view illustrating the movement of a display position after an alignment adjustment.

FIG. 9 is a view illustrating the quantitative relationship (L1≧5×L2) between a distance L1 and a distance L2.

FIGS. 10A and 10B are views illustrating an alignment adjustment.

FIG. 11A is a top view illustrating a wearable device when implementing a front view configuration, and FIG. 11B is a top view illustrating a wearable device when implementing a right side view configuration.

FIG. 12A illustrates a first configuration example of an optical system of a display, FIG. 12B illustrates a second configuration example of an optical system of a display, and FIG. 12C illustrates a third configuration example of an optical system of a display.

FIG. 13 illustrates a configuration example of a rotation axis.

FIG. 14A illustrates a first arrangement example of a second rotation axis and an eyepiece window, and FIG. 14B illustrates a second arrangement example of a second rotation axis and an eyepiece window.

FIGS. 15A and 15B illustrate a modification of a display position adjustment mechanism.

FIG. 16 illustrates a second configuration example of a wearable device according to one embodiment of the invention.

FIGS. 17A and 17B are views illustrating an alignment adjustment according to a second configuration example.

FIG. 18 is a view illustrating an alignment adjustment according to a second configuration example.

### DESCRIPTION OF EXEMPLARY EMBODIMENTS

An object of several aspects and embodiments of the invention is to provide a wearable device that can simplify an adjustment that adjusts the position of an eyepiece element with respect to a human eye to a position (area) based on ergonomics, and causes the optical axis of the eyepiece element to (approximately) coincide with the visual axis of the user.

According to the above configuration, since the first rotation axis and the second rotation axis are provided at the ergonomically optimum positions, it is possible to place the eyepiece element in an optimum area by performing the first-step operation. In this case, when the optical axis of the eyepiece element and the line of sight of the user (approximately) coincide with each other, it is possible to immediately observe the display image through the eyepiece element without making an adjustment. Even when the optical axis of the eyepiece element and the line of sight of the user do not (approximately) coincide with each other (i.e., part of the display image cannot be observed), it is possible to immediately (easily) cause the optical axis of the eyepiece element and the line of sight of the user to coincide with each other by performing the second-step operation.

Exemplary embodiments of the invention are described below. Note that the following exemplary embodiments do not in any way limit the scope of the invention laid out in the claims. Note also that all of the elements described below in connection with the exemplary embodiments should not necessarily be taken as essential elements of the invention.

### 1. Wearable Device

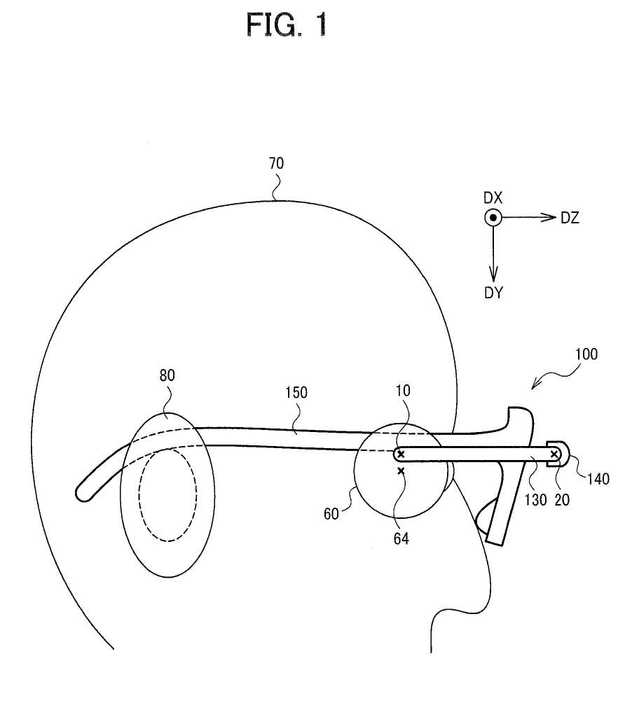

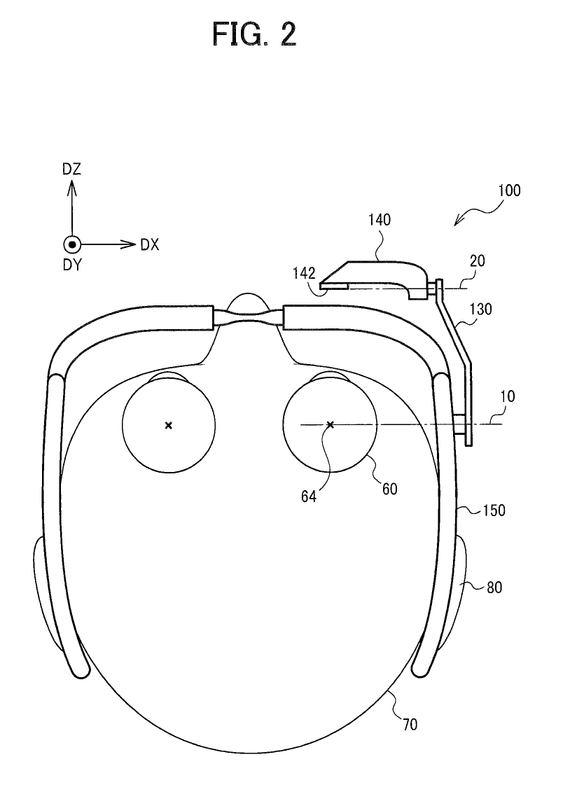

FIGS. 1 and 2 illustrate a configuration example of a wearable device 100 according to one embodiment of the invention. FIG. 1 is a side view illustrating a head 70 (i.e., the side of the head 70) on which the wearable device 100 is worn, and FIG. 2 is a top view illustrating the head 70 (i.e., the top of the head 70) on which the wearable device 100 is worn. The directions DX, DY, and DZ are respectively the rightward direction, the downward direction, and the forward direction with respect to the head 70, and are orthogonal to each other. When the wearer stands upright, the direction DY is a direction that extends vertically downward, and the directions DX and DZ are directions that extend horizontally.

The wearable device 100 includes a wearable element that is worn on the head 70 of the wearer, a connector 130 that is connected to the wearable element so as to be rotatable around a first rotation axis 10, and a display 140 that is connected to the connector 130 so as to be rotatable around a second rotation axis 20, and displays a virtual image within part of the field of view of the wearer.

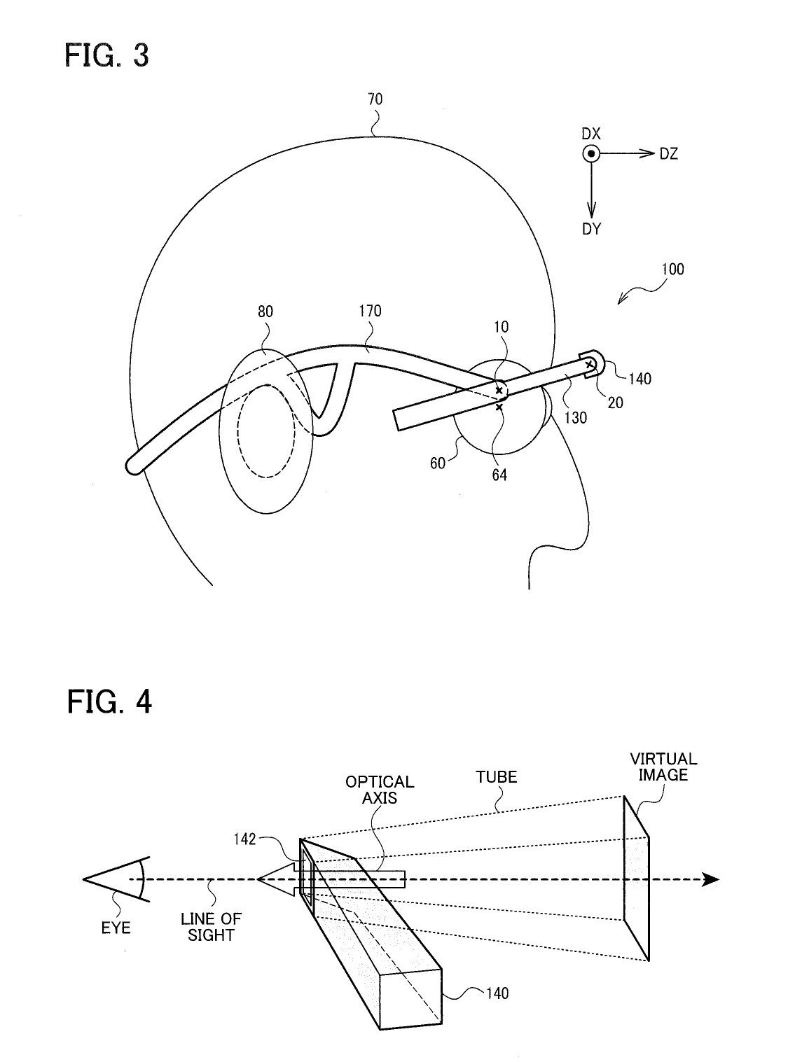

In the configuration example illustrated in FIGS. 1 and 2, the wearable element is an eyeglass-type frame 150, and includes a temple and a front, the temple being used to secure the eyeglass-type frame 150 on an ear 80. The front includes two rims (lens frames), a bridge that connects the two rims, and a nose pad that is used to secure the front on the nose, for example. Note that the wearable element is not limited to the eyeglass-type frame 150. It suffices that the wearable element be designed so that the wearable device 100 can be secured on the head 70. For example, the wearable element may be a neck band 170 illustrated in FIG. 3, or may be a head band.

The connector 130 is an element that connects the wearable element and the display 140. The connector 130 supports the display 140 (eyepiece window 142) in front of an eyeball 60 and the front of the eyeglass-type frame 150. When the wearable element is the neck band 170, the connector 130 supports the display 140 in front of the eyeball 60. The connector 130 and the wearable element are connected through a rotation mechanism (e.g., shaft (shaft protrusion) and bearing), and the rotation (rotation in both directions (clockwise direction and counterclockwise direction)) around the first rotation axis 10 is implemented by means of the rotation mechanism. Likewise, the display 140 and the connector 130 are connected through a rotation mechanism (e.g., shaft (shaft protrusion) and bearing), and the rotation around the second rotation axis 20 is implemented by means of the rotation mechanism.

The connector 130 includes a rod-like member (that may be curved or bent, and may have a non-uniform thickness), for example. A first end (i.e., one end) of the rod-like member is connected to the display 140, and a second end (i.e., the other end) of the rod-like member is connected to the wearable element. Alternatively, the first end of the rod-like member may be connected to the display 140, and an area of the rod-like member that is situated between the first end and the second end may be connected to the wearable element. Note that the shape and the connection positions of the connector 130 are not limited to the examples described above.

The display 140 is configured to guide light (image) output from a display device to the eyepiece window 142 through an optical system, and emit the guided light from the eyepiece window 142 toward the pupil of the eyeball 60 (i.e., emit the guided light in the direction along the line of sight of the eyeball 60 (visual axis direction)) to display an enlarged virtual image of the image within the field of view (i.e., project the image onto the retina). The display device may be implemented by a liquid crystal display device, a self-emitting display device (e.g., EL display device), or a scanning-type display device that scans the retina with spot light, for example. Note that the term “line of sight” used herein refers to a line that connects the eyeball 60 and the viewing target object, or refers to the viewing direction of the eyeball 60. More specifically, the term “line of sight” used herein refers to a line that extends along the optical axis of the eyeball 60 when the viewing target object is being viewed, or refers to a direction that extends along the optical axis. The term “visual axis” used herein refers to the optical axis of the eyeball 60.

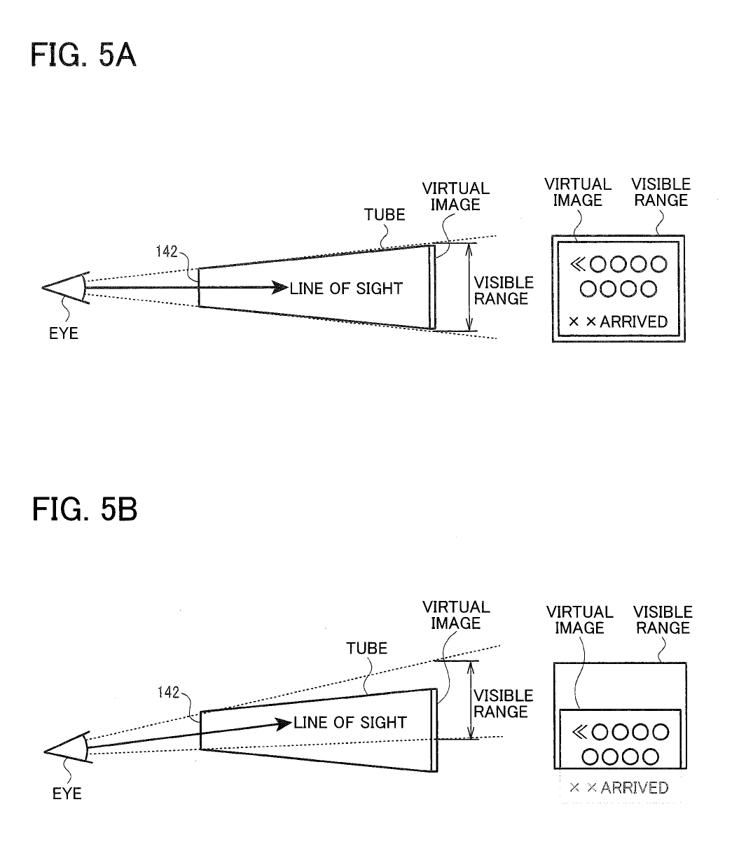

FIGS. 4 to 5B schematically illustrate the way in which the virtual image is viewed through the eyepiece window 142. An example that utilizes a pupil-division see-through optical system is described below. The pupil-division see-through optical system is designed so that the exit pupil of the optical system is set at a point around the eyepiece lens (eyepiece window 142) such that the size of the eyepiece lens can be reduced. Since the size of the eyepiece lens is small, light enters the pupil of the eye from the external field of view through the outside of the eyepiece lens to implement see-through display. When using the pupil-division see-through optical system, the width of the end part (in which the eyepiece window 142 is provided) of the display 140 is 4 mm or less, for example. Note that the optical axis adjustment method according to one embodiment of the invention may also be applied to a head-mounted display that utilizes various optical systems other than the pupil-division see-through optical system.

As illustrated in FIG. 4, the virtual image projected through the optical system of the display 140 is observed as if the virtual image were situated on the front side of the eyepiece window 142 with respect to the eye. Specifically, the virtual image is observed through the eyepiece window 142 (i.e., the virtual image is observed through a virtual tube that connects the eyepiece window 142 and the virtual image).

As illustrated in FIG. 5A, when the line of sight (visual axis) and the eyepiece optical axis approximately coincide with each other, and the wearer directly looks into the tube, the entire virtual image is observed to be situated within the eyepiece window 142, and the entire display image can be observed through the eyepiece window 142. As illustrated in FIG. 5B, when the line of sight and the eyepiece optical axis do not coincide with each other, and the wearer obliquely looks into the tube, the virtual image is observed to be shifted with respect to the eyepiece window 142 (i.e., only part of the virtual image is situated within the eyepiece window 142), and only part of the display image can be observed (or the entire display image cannot be observed).

Since the pupil-division see-through optical system displays an image within part of the field of view (e.g., within a field of view (viewing angle) of 10 to 15°), it is possible to display the image in the peripheral area of the field of view instead of the center of the field of view. Specifically, the wearer can read the information displayed within the image by optionally observing the eyepiece window 142 situated in the peripheral area of the field of view while maintaining a clear sight at the center of the field of view. When an optical system that allows the wearer to arbitrarily change the display position is used, it is considered that the wearer positions the eyepiece window 142 (display position) when the head-mounted display has been worn, or changes the position of the eyepiece window 142 (display position) during use, for example. In this case, it is necessary to make an adjustment so that the entire image can be observed.

For example, when the wearer desires to display the image on the upper side with respect to the center of the field of view, the wearer positions the eyepiece window 142 on the upper side with respect to the center of the eye (see FIG. 5B). If the entire display image cannot be observed, it is necessary to make an adjustment (correction) so that the entire display image can be observed. In this case, it is highly convenient if an adjustment can be made while maintaining the position of the eyepiece window 142 as much as possible (i.e., without changing the display position). When an adjustment has been made so that the entire display image can be observed (see FIG. 5A), it is desirable that a further adjustment be unnecessary (i.e., the entire display image can be observed without making an adjustment) even if the display position has been moved (changed).

The wearable device 100 according to one embodiment of the invention that is provided with the first rotation axis 10 and the second rotation axis 20 can solve the above problem as described below.

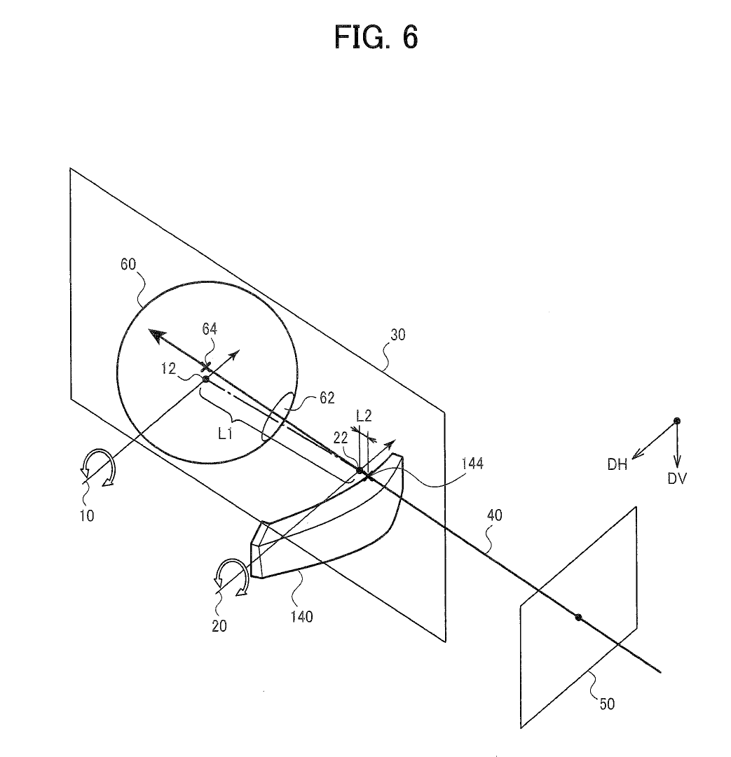

FIG. 6 schematically illustrates the positions of the first rotation axis 10, the second rotation axis 20, the eyeball 60, and the display 140 when the wearer wears the wearable device 100.

A virtual plane 30 is a (virtual) plane that includes an eyepiece optical axis 40 of the display 140 and intersects the first rotation axis 10 and the second rotation axis 20. A first intersection 12 is the intersection of the virtual plane 30 and the first rotation axis 10. A second intersection 22 is the intersection of the virtual plane 30 and the second rotation axis 20. A distance L1 is the distance from the first intersection 12 to the second intersection 22, and a distance L2 is the distance from the second intersection 22 to an exit end 144 of the eyepiece optical axis 40 (an intersection of an eyepiece and the eyepiece optical axis 40).

The eyepiece optical axis 40 is the optical axis of the eyepiece-side end (eyepiece window 142) of the display 140. Since the display 140 is configured so that the light (image) is reflected (or refracted) within the optical system in order to guide the light (image) to the eyepiece window 142, the direction of the optical axis changes each time the reflection (or refraction) occurs. The eyepiece optical axis 40 is the optical axis of the part that emits the light toward the eye. The exit end of the eyepiece optical axis 40 corresponds to the intersection of the part of the optics that emits the light toward the eye, and the eyepiece optical axis 40. For example, when an eyepiece lens is provided to the eyepiece window 142, and the eyepiece lens is the final optical element, the exit end is the intersection of the eyepiece lens and the eyepiece optical axis 40. When a prism or a mirror is provided on the inner side of the eyepiece window 142, and the prism or the mirror is the final optical element, the exit end is the intersection of the prism or the mirror and the eyepiece optical axis 40.

The distance L1 and the distance L2 defined as described above satisfy the relationship “20 mm≧L1+L2≧45 mm”. Note that the distance L1 and the distance L2 desirably satisfy the relationship “30 mm≧L1+L2≧35 mm”

It is considered in terms of ergonomics that the radius of the eyeball 60 is about 12 mm, the distance from the pupil of the eyeball 60 to the eyeglass lens is about 12 mm, and the dimension of the space required to prevent a situation in which the display 140 comes in contact with the eyeglass lens when the display 140 is rotated around the first rotation axis 10 is about 6 mm Since the sum of the radius of the eyeball 60, the distance from the pupil of the eyeball 60 to the eyeglass lens, and the dimension of the space is about 30 mm, the first rotation axis 10 passes through a point around an eyeball center 64 when the value “L1+L2” is set to about 30 mm. Note that these values are average values determined in terms of ergonomics, and may vary due to individual variations, the shape of the wearable element, and the like. Specifically, various design values are ergonomically determined so that the first rotation axis 10 passes through a point around the eyeball center 64 when designing the wearable device.

The distance L1 and the distance L2 may be set so that the relationship “about 20 mm<L1+L2<about 45 mm” is satisfied, for example The lower limit (20 mm) is set taking account of the case where an eyeglass lens is not provided (e.g., neck band 170), and the upper limit (45 mm) is set taking account of practical utility and the like.

More specifically, the lower limit (20 mm) is calculated by adding up the radius (about 12 mm) of the eyeball 60 and the dimension (about 8 mm) of the space required to prevent a situation in which the display 140 comes in contact with the eyelashes. The upper limit (45 mm) is set taking account of the limit by which the entire virtual image can be observed through the eyepiece window 142 in addition to the fact that the value “L1+L2” increases due to a usage state in which protective glasses are worn over the eyeglasses, the racial difference in the distance from the eyeball center to the eyeglass lens, and the like. For example, when the width of the eyepiece window 142 is set to 4 mm, and the value “L1+L2” is set to 45 mm, the viewing angle with respect to the widthwise direction of the eyepiece window 142 is about 5.1°. Since the field of view of the pupil-division see-through optical system in the widthwise direction (i.e., vertical field of view) is typically 5 to 9°, it is difficult to observe the image through the center of the pupil when the value “L1+L2” is larger than 45 mm Moreover, the size of the eye-box (i.e., a range in which the entire image can be observed even if the position of the eye has changed) significantly decreases, and it becomes necessary to make a severe adjustment with regard to the visual axis and the eyepiece optical axis. Therefore, it is practically difficult to set the value “L1+L2” to be larger than 45 mm. The upper limit (45 mm) is set also taking account of a situation in which the support strength decreases or operation is hindered if the display 140 is significantly situated away from the eyeglasses, and the display swings to a large extent along with the motion of the head due to an increase in moment, for example. Note that each of the above values varies depending on individual variations and the like, and the lower limit (20 mm) and the upper limit (45 mm) may be changed to some extent.

In any case, when the first rotation axis 10 and the second rotation axis 20 are provided so that the relationship “20 mm<L1+L2<45 mm” is satisfied, it is possible to implement a state in which the first rotation axis 10 passes through a point around the eyeball center 64. When the first rotation axis 10 and the second rotation axis 20 are provided in such a manner, it is possible to easily adjust the angle of the eyepiece optical axis 40 (i.e., make an adjustment that causes the line of sight and the eyepiece optical axis 40 to approximately coincide with each other when the pupil 62 (line of sight) has been turned on the virtual image 50). When the first rotation axis 10 passes through a point around the eyeball center 64, the display image can be observed even if the display position has been changed after an adjustment has been made so that the display image can be observed.

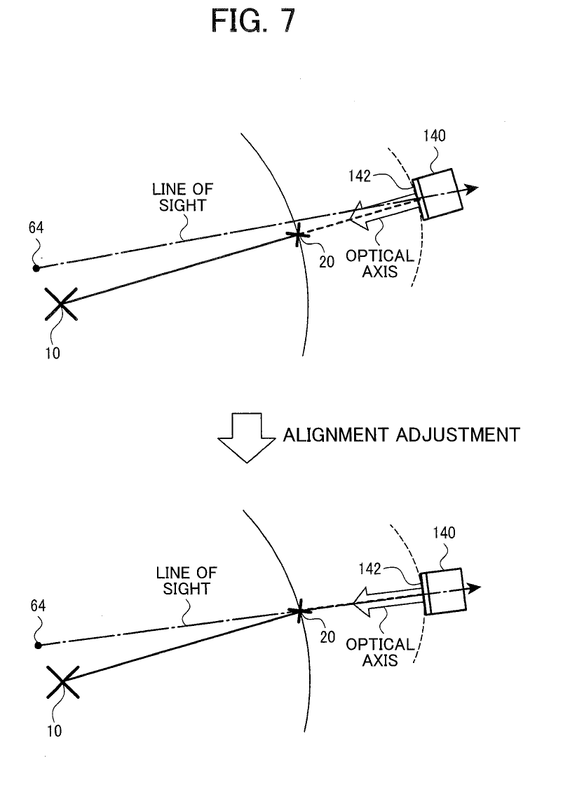

Specifically, the wearer (user) adjusts the display position to the desired position by rotating the display 140 around the first rotation axis 10 (see the upper part of FIG. 7). The wearer then rotates the display 140 around the second rotation axis 20 so that the line of sight and the eyepiece optical axis (approximately) coincide with each other such that the entire display image can be observed (alignment adjustment) (see the lower part of FIG. 7). Specifically, it is possible to sequentially perform the position adjustment and the alignment adjustment (i.e., adjustment of the direction of the optical axis) by a simple operation as a result of providing the first rotation axis 10 and the second rotation axis 20.

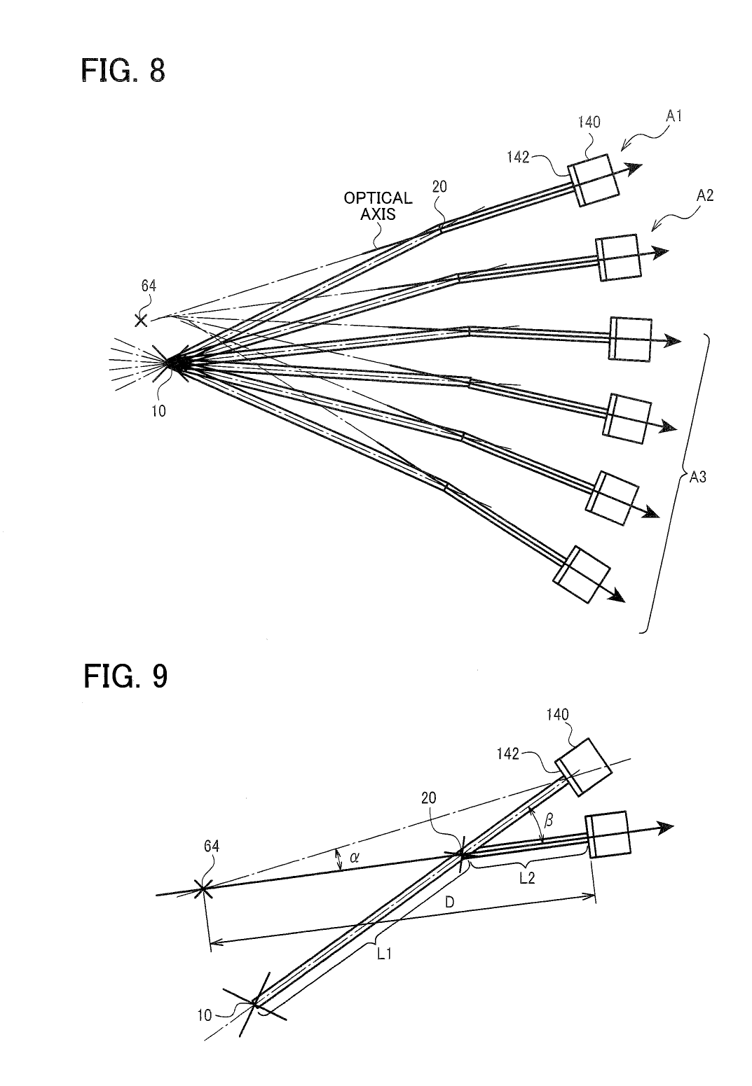

FIG. 8 illustrates a state after the above adjustment has been performed (see A2). As illustrated in FIG. 8, the optical axis passes through the eyeball center, and the optical axis and the line of sight coincide with each other. The display 140 is rotated around the first rotation axis 10 when it is desired to move the display position upward (see A1) or downward (see A3). In this case, since the first rotation axis 10 passes through a point around the eyeball center, the optical axis approximately passes through the eyeball center (i.e., the line of sight and the optical axis are shifted from each other to only a small extent) even when the display 140 is rotated around the first rotation axis 10. Therefore, the entire display image can be observed even if the display position is changed after the display position has been determined, and the alignment adjustment has been performed. Even if part of the display image cannot be observed, it is possible to easily perform the alignment adjustment again since it suffices to perform a minor adjustment.

As described above, since the first rotation axis 10 and the second rotation axis 20 are provided at the ergonomically optimum positions, it is possible to place the eyepiece element in an optimum area by performing the first-step operation (see the upper part of FIG. 7). In this case, when the optical axis of the eyepiece element and the line of sight of the user (approximately) coincide with each other, it is possible to immediately observe the display image through the eyepiece element without making an adjustment. Even when the optical axis of the eyepiece element and the line of sight of the user do not (approximately) coincide with each other (i.e., part of the display image cannot be observed), it is possible to immediately (easily) cause the optical axis of the eyepiece element and the line of sight of the user to coincide with each other by performing the second-step operation (alignment adjustment) (see the lower part of FIG. 7).

In one embodiment of the invention, the distance L1 and the distance L2 are set to satisfy the relationship “L1≧5×L2”. Specifically, the ratio “L1/L2” of the distance L1 to the distance L2 is larger than 5. It is most ideal that the distance L2 be 0 mm (L2=0 mm)

FIG. 9 is a view illustrating the quantitative relationship (L1≧5×L2) between the distance L1 and the distance L2. FIG. 9 illustrates an example in which the display position has been changed by rotating the display 140 around the first rotation axis 10 in a state in which the line of sight and the optical axis have been caused to coincide with each other through the alignment adjustment. In this case, the alignment adjustment is performed again so that the line of sight and the optical axis coincide with each other. The correction angle around the second rotation axis 20 (i.e., a change in the angle of a straight line that connects the second rotation axis 20 and the exit end of the optical axis) due to the alignment adjustment is referred to as 13. A change in elevation angle (i.e., a change in the angle of a straight line that connects the eyeball center and the exit end of the optical axis) due to the alignment adjustment is referred to as a. The distance from the eyeball center to the exit end of the optical axis when the line of sight and the optical axis have been caused to coincide with each other is referred to as D.

As illustrated in FIG. 9, the following expression (1) is satisfied.

tan α=L2×sin β/(D−L2+L2×cos β) (1)

Since the change a in elevation angle and the correction angle β are equal to or less than about 10°, the following expression (2) is approximately satisfied based on the expression (1). Note that the change a in elevation angle and the correction angle β are exaggerated in FIG. 9 for convenience of explanation.

α=L2×β/D (2)

When the first rotation axis 10 passes through a point around the eyeball center, the distance D can be approximated to the distance “L1+L2”. When L1≦P×L2, the following expression (3) is satisfied based on the expression (2).

α⊖β/(P+1) (3)

The change α in elevation angle corresponds to the change in display position due to the alignment adjustment. It is preferable that the change in display position due to the alignment adjustment be as small as possible. When P=5, and the correction angle β is approximately equal to the field of view in the vertical direction (hereinafter may be referred to as “vertical FOV”) with respect to the display image (i.e., one screen in the vertical direction), the relationship “α≦β/6” is satisfied (i.e., the change in elevation angle is smaller than ⅙th of the vertical FOV (i.e., ⅙th of the screen in the vertical direction)). Since the vertical FOV when using the pupil-division see-through optical system is about 5 to 9°, the change a in elevation angle is smaller than 1.5°, and a change in display position occurs to only a small extent even when the alignment adjustment is performed corresponding to one screen in the vertical direction. When the value P is sufficiently larger than 5 (i.e., L1>>L2), the change a in elevation angle is approximately 0° (i.e., a change in elevation angle due the alignment adjustment does not occur (i.e., a change in display position does not occur)).

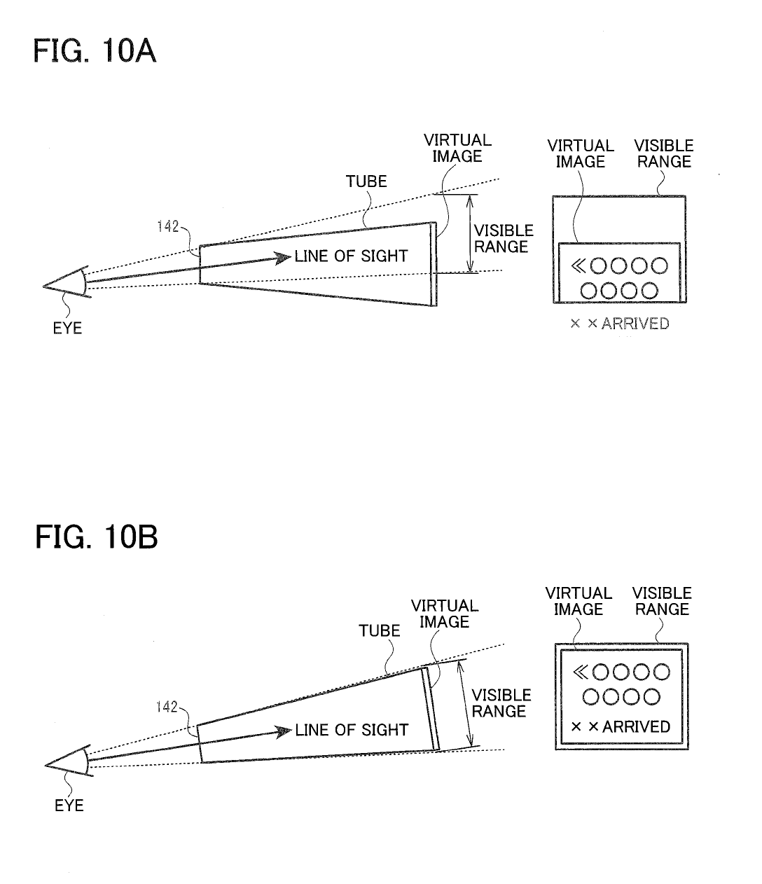

FIG. 10A illustrates an example in which the display position has been moved upward, and the lower part of the virtual image cannot be observed. According to one embodiment of the invention, since the alignment adjustment can be implemented without causing a change in the elevation angle of the line of sight (see FIG. 10B), it is possible to make an adjustment so that the entire virtual image can be observed through the eyepiece window without changing the display position (i.e., the position of the display window) that has been determined

As described above, it is possible to reduce a change in display position due to the alignment adjustment by providing the first rotation axis 10 and the second rotation axis 20 so that the relationship “L1≧5×L2” is satisfied. Specifically, when performing the two-step adjustments described above with reference to FIG. 7, it is possible to implement the alignment adjustment while preventing a situation in which the display position determined by the first step is changed to a large extent. If the display position has been changed due to the alignment adjustment, it is necessary to finely adjust the display position again. According to one embodiment of the invention, it suffices to perform only the two-step adjustments.

In one embodiment of the invention, the distance L2 is set to be equal to or less than 5 mm (L2≦5 mm).

The condition “L2=5 mm” is obtained by applying a typical value “L1+L2=30 mm” to L1=5×L2 (P=5). Specifically, when the distance L2 is set to be equal to or less than 5 mm (L2≦5 mm), it is possible to reduce a change in display position due to the alignment adjustment (as described above with reference to FIG. 9), and implement the two-step adjustments (i.e., adjustment of display position and alignment adjustment).

According to one embodiment of the invention, the virtual plane 30 that includes the eyepiece optical axis 40 and the first rotation axis 10 are (approximately) orthogonal to each other, and the virtual plane 30 and the second rotation axis 20 are (approximately) orthogonal to each other (see FIG. 6, for example). Note that the virtual plane 30 need not necessarily be perfectly orthogonal to the first rotation axis 10 and the second rotation axis 20. For example, it suffices that the virtual plane 30 form an angle of 80 to 90° with the first rotation axis 10 and the second rotation axis 20. Even when the virtual plane 30 is designed to be orthogonal to the first rotation axis 10 and the second rotation axis 20, individual variations due to tolerance and the like are acceptable.

When the virtual plane 30 are orthogonal to both the first rotation axis 10 and the second rotation axis 20, the first rotation axis 10 and the second rotation axis 20 are orthogonal to the eyepiece optical axis 40, and are parallel to each other.

When the first rotation axis 10 is tilted with respect to the eyepiece optical axis 40, a component of rotation around the axis orthogonal to the eyepiece optical axis 40 and a component of rotation around the eyepiece optical axis 40 are mixed when the display 140 is rotated around the first rotation axis 10. Therefore, the display image is rotated around the eyepiece optical axis 40 due to the component of rotation around the eyepiece optical axis 40, and it is necessary to provide a further adjustment mechanism that corrects the rotation of the display image. This also applies to the case where the second rotation axis 20 is tilted with respect to the eyepiece optical axis 40. According to one embodiment of the invention, since the first rotation axis 10 and the second rotation axis 20 are (approximately) orthogonal to the eyepiece optical axis 40, the rotation of the display image around the eyepiece optical axis 40 rarely occurs when an adjustment around the first rotation axis 10 or the second rotation axis 20 is performed.

When the first rotation axis 10 does not exactly pass through the eyeball center 64, the eyepiece optical axis 40 is shifted from the eyeball center 64 when the display 140 is rotated around the first rotation axis 10. In this case, the shift of the eyepiece optical axis 40 from the eyeball center 64 occurs in a plane that passes through the eyepiece optical axis 40 and is orthogonal to the first rotation axis 10. Likewise, when the direction of the eyepiece optical axis 40 is adjusted around the second rotation axis 20, the movement of the eyepiece optical axis 40 occurs in a plane that passes through the eyepiece optical axis 40 and is orthogonal to the second rotation axis 20.

According to one embodiment of the invention, since the first rotation axis 10 and the second rotation axis 20 are parallel to each other, the movement of the eyepiece optical axis 40 occurs in an identical plane (virtual plane 30), and the direction of the eyepiece optical axis 40 that has been shifted due to the movement of the display position around the first rotation axis 10 can be adjusted around the second rotation axis 20 (i.e., alignment adjustment).

According to one embodiment of the invention, the virtual plane 30 is parallel to the vertical scan direction DV of the image that is displayed as the virtual image 50 (see FIG. 6, for example).

The display device is configured to repeat an operation that sequentially selects the pixels along the scan line, and writes the pixel value into the selected pixels to display an image that corresponds to one screen. The direction that extends along the scan line is referred to as “horizontal scan direction”, and the direction that is orthogonal to the horizontal scan direction is referred to as “vertical scan direction”. The horizontal scan direction DH and the vertical scan direction DV illustrated in FIG. 6 are directions with respect to the virtual image that correspond to the directions defined with respect to the screen of the display device.

The vertical scan direction DV normally approximately coincides with the upward-downward direction of the field of view of the wearer. Since the virtual plane 30 is parallel to the vertical scan direction DV, the first rotation axis 10 that is orthogonal to the virtual plane approximately coincides with the rightward-leftward direction of the field of view. In this case, when the first rotation axis 10 of the eyeglass-type frame 150 illustrated in FIG. 1, the neck band 170 illustrated in FIG. 4, or the like is provided around the temple of the wearer, the first rotation axis 10 passes through a point around the eyeball center 64. In this case, the first rotation axis 10 (i.e., the connection point of the wearable element and the connector 130) is situated to coincide with the temple of the eyeglass-type frame 150 or the ear piece of the neck band 170 (i.e., the connector 130 is attached to the wearable element at a natural position).

According to one embodiment of the invention, it suffices that the first rotation axis 10 pass through the eyeball 60 of the wearer when the wearable element is worn on the head 70.

Although an example in which the first rotation axis 10 passes through a point around the eyeball center 64 as a result of providing the first rotation axis 10 and the second rotation axis 20 so that the relationship “L1+L2=30 mm” is satisfied has been described above with reference to FIG. 6 and the like, it suffices that the first rotation axis 10 pass through the eyeball 60 in order to implement the adjustment of the display position and the alignment adjustment. It is desirable that the first rotation axis 10 pass through a point within 6 mm (i.e., half of the radius of the eyeball 60) from the eyeball center 64. Note that the eyeball center 64 refers to the center of a sphere when the eyeball 60 is considered to be a sphere.

Since the position of the eyeball 60, the positional relationship between the eyeball 60 and the ear 80 or the nose, the radius of the eyeball 60, and the like differ between individuals, the positional relationship between the first rotation axis 10 and the eyeball 60 also differs between individuals when an identical wearable device 100 is used. Therefore, it suffices that the wearable device 100 be designed so that the first rotation axis 10 passes through the eyeball 60 of 90% of the wearers, for example.

According to one embodiment of the invention, the first rotation axis 10 is a rotation axis around which the display 140 is rotated to adjust the display position of the virtual image 50 within the field of view (see FIG. 7, for example). The second rotation axis 20 is a rotation axis around which the display 140 is rotated to adjust the direction of the eyepiece optical axis 40.

Although the positional conditions with regard to the first rotation axis 10 and the second rotation axis 20 that implement the above functions have been described above with reference to FIG. 6 and the like, the wearable device 100 need not necessarily satisfy all of the positional conditions described above with reference to FIG. 6 and the like. Specifically, it suffices that the wearable device 100 be configured to implement the above functions. It is possible to implement an adjustment mechanism that can reduce the burden imposed on the user by implementing the adjustment of the display position and the alignment adjustment using the first rotation axis 10 and the second rotation axis 20, respectively. The above configuration is particularly effective for a head-mounted display in which the size of the eyepiece window 142 is small (e.g., a head-mounted display that utilizes a pupil-division see-through optical system). Note that the invention can also be applied to a head-mounted display that utilizes another optical system. For example, even when the optical system is configured so that the image can be observed in a state in which the line of sight and the eyepiece optical axis do not coincide with each other, it is difficult to sufficiently bring out the optical performance of the eyepiece element when the line of sight and the eyepiece optical axis do not coincide with each other. However, it is possible to sufficiently bring out the optical performance by utilizing the adjustment mechanism according to one embodiment of the invention.

### 2. Detailed Configuration and Modifications

The detailed configuration of each section of the wearable device 100 and various modifications are described below.

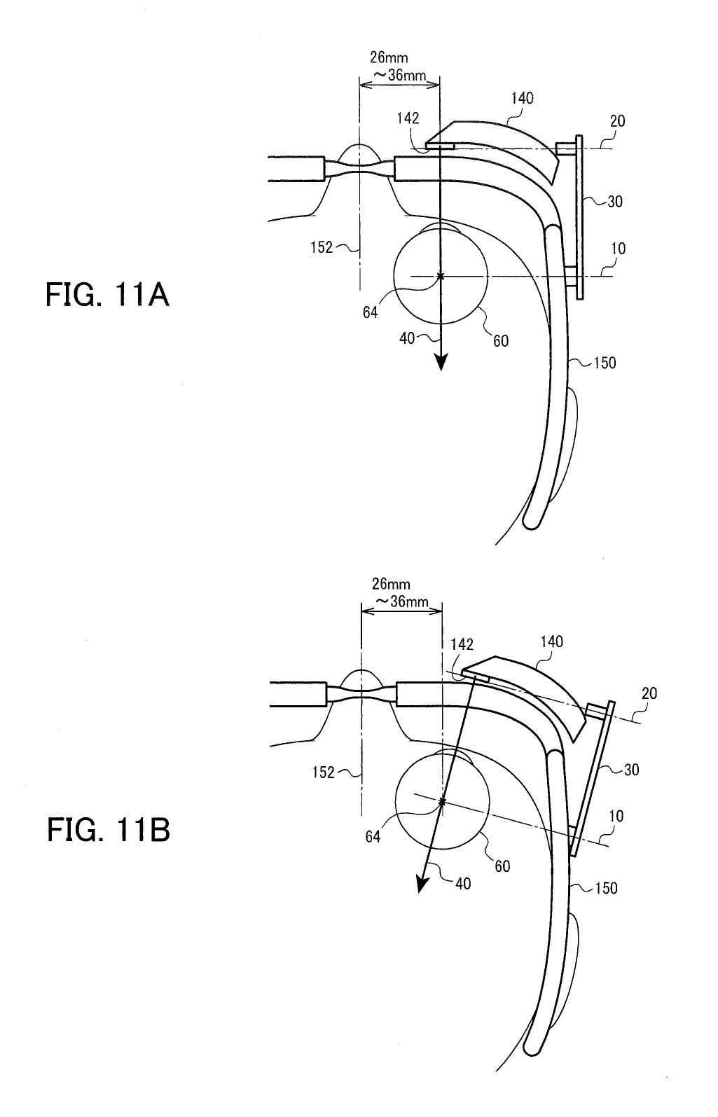

FIG. 11A is a top view illustrating the wearable device 100 when implementing a front view configuration, and FIG. 11B is a top view illustrating the wearable device 100 when implementing a right side view configuration.

When implementing the front view configuration, the eyepiece optical axis 40 that passes through the eyeball center 64 corresponds to the forward-backward direction (situated in the DZ-DY plane). Specifically, the display image is displayed at the center of the field of view, or displayed in the vicinity of the center of the field of view in the upward-downward direction. When implementing the right side view configuration, the eyepiece optical axis 40 that passes through the eyeball center 64 is tilted to the right. Specifically, the display image is displayed on the right side of the center of the field of view, or displayed in the vicinity of the right side of the center of the field of view in the upward-downward direction. When implementing the front view configuration and the right side view configuration, the distance from the eyeball center 64 to the eyepiece window 142 is about 30 mm (=12 mm+12 mm+6 mm) The distance between a symmetry plane 152 of the eyeglass-type frame 150 (wearable element) and the eyeball center 64 is about 26 to 36 mm (see FIGS. 11A and 11B (top views)). The first rotation axis 10 is set taking account of these dimensions so that the first rotation axis 10 passes through a point around the eyeball center 64.

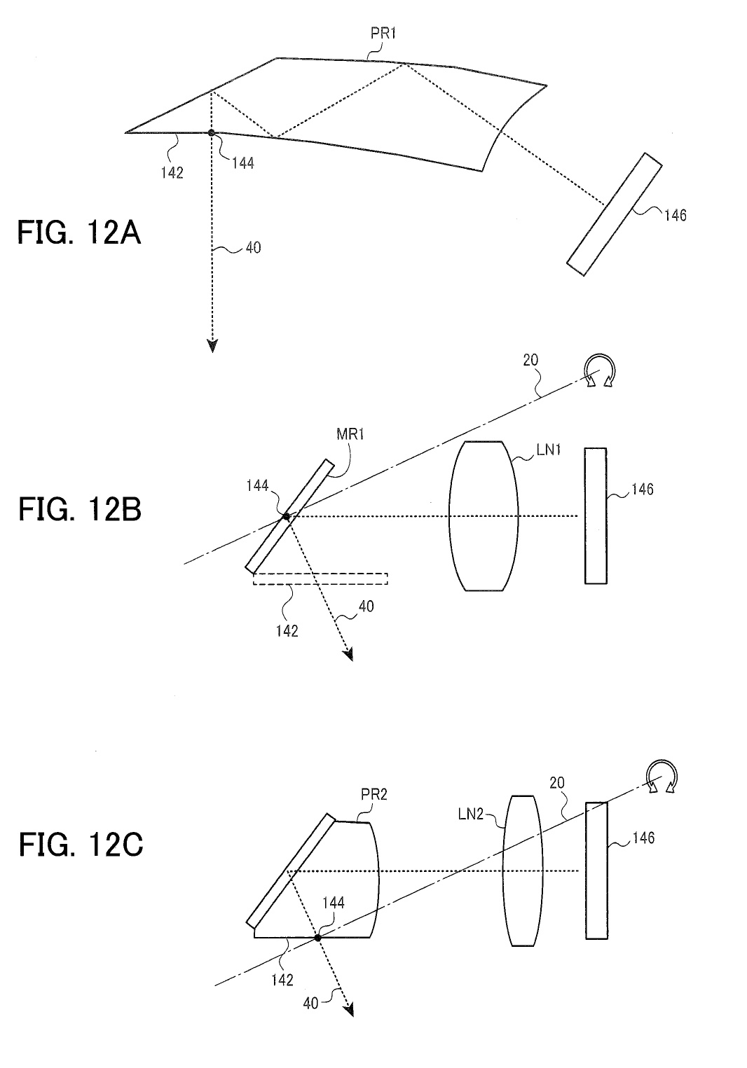

FIG. 12A illustrates a first configuration example of the optical system of the display 140, FIG. 12B illustrates a second configuration example of the optical system of the display 140, and FIG. 12C illustrates a third configuration example of the optical system of the display 140.

The optical system according to the first configuration example includes a display panel 146 and a prism PR1. The prism PR1 guides light from the display panel 146 to the eyepiece window 142 while reflecting the light within the prism PR1 a plurality of times. The prism PR1 has a positive diopter (power or refractive power) due to the incident end face and the shape of the reflection plane to project the virtual image onto the eye. According to the first configuration example, the end face of the prism PR1 through which the light exits from the optical system corresponds to the eyepiece window 142, and the intersection of the end face and the eyepiece optical axis 40 (exit optical axis) corresponds to the exit end 144 of the eyepiece optical axis 40. The optical system according to the first configuration example is configured so that the optical axis of the display panel 146 and the eyepiece optical axis 40 form an acute angle, and the light is guided by the prism PR1, and the display 140 has a shape along the curved surface of the eyeglass frame.

The optical system according to the second configuration example includes a display panel 146, a lens LN1, and a mirror MR1. Light from the display panel 146 passes through the lens LN1 that has a positive diopter, is reflected by the mirror MR1, and exits from the optical system through the eyepiece window 142. According to the second configuration example, the opening of the housing through which the light reflected by the mirror MR1 exits from the optical system corresponds to the eyepiece window 142. The intersection of the reflection plane of the mirror MR1 and the eyepiece optical axis 40 corresponds to the exit end 144 of the eyepiece optical axis 40. The optical system according to the second configuration example is configured so that the mirror MR1 reflects the light (bends the optical axis) at an acute angle, and the display 140 is formed to follow the curved surface of the eyeglass frame as much as possible.

The optical system according to the third configuration example includes a display panel 146, a lens LN2, and a prism PR2. Light from the display panel 146 passes through the lens LN2, enters the prism PR2, is reflected by the reflection plane of the prism PR2, and exits from the optical system through the end face of the prism PR2. The optical system has a positive diopter due to the shape of the incidence plane of the prism PR2 and the lens LN2. According to the third configuration example, the end face of the prism PR2 through which the light exits from the optical system corresponds to the eyepiece window 142, and the intersection of the end face and the eyepiece optical axis 40 corresponds to the exit end 144 of the eyepiece optical axis 40. The optical system according to the third configuration example is configured so that the prism PR2 reflects the light (bends the optical axis) at an acute angle, and the display 140 is formed to follow the curved surface of the eyeglass frame as much as possible.

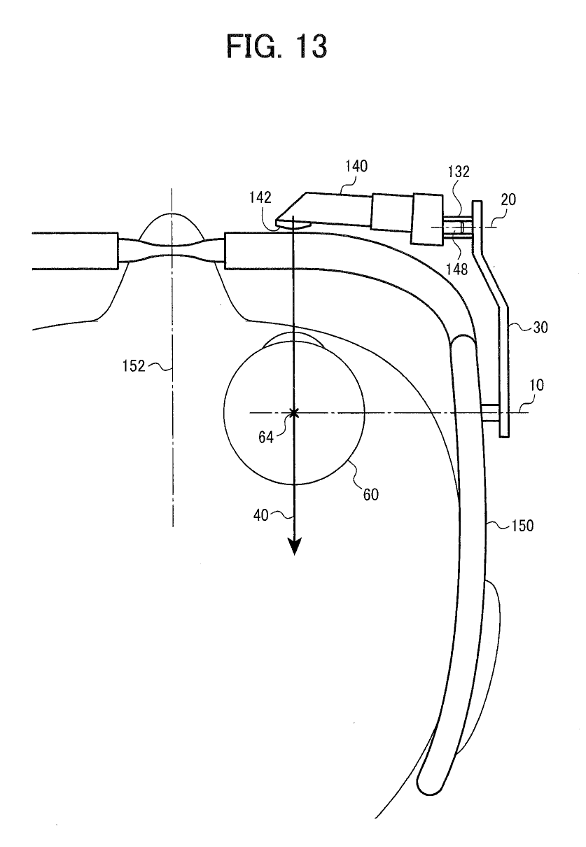

FIG. 13 illustrates a configuration example of the rotation axis. A shaft 148 (columnar protrusion) protrudes from the housing of the display 140, and a cylindrical bearing 132 protrudes from the connector 130. The shaft 148 is fitted into the bearing 132, and rotated within the bearing 132 to implement the rotation around the second rotation axis 20. The symmetry axis of the shaft 148 (columnar protrusion) and the symmetry axis of the bearing 132 (cylindrical structure) correspond to the second rotation axis 20.

The first rotation axis 10 can be implemented using a similar configuration. In the example illustrated in FIG. 13, the front and the temple of the eyeglass-type frame 150 are connected through a hinge, and a bearing that corresponds to the first rotation axis 10 is provided to the temple. Note that a bearing that corresponds to the first rotation axis 10 may be provided to the front of the eyeglass-type frame 150.

Note that a bearing that corresponds to the second rotation axis 20 may be provided to the display 140. A bearing that corresponds to the first rotation axis 10 may be provided to the temple. The eyeglass-type frame 150 may have a configuration in which the front and the temple are integrally formed without providing a hinge, and a bearing that corresponds to the first rotation axis 10 is provided to the frame that is integrally formed.

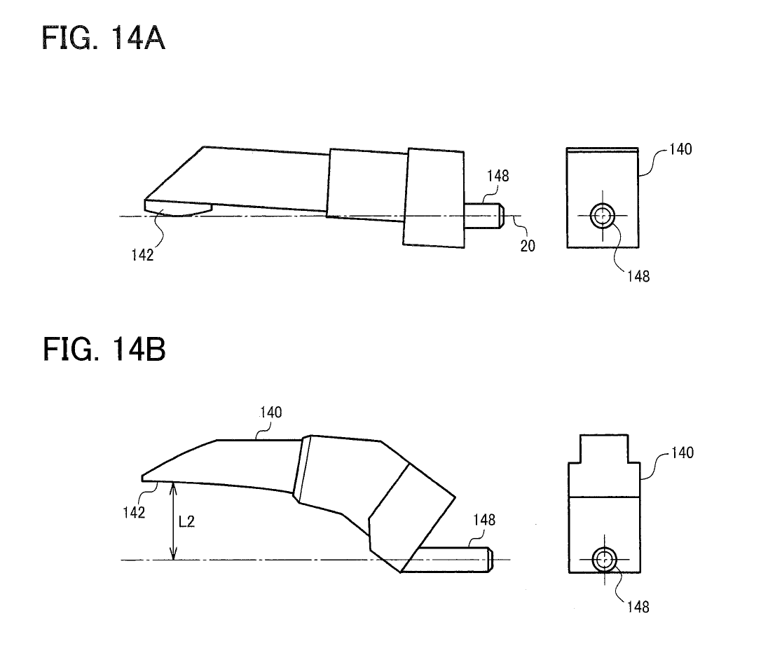

FIG. 14A illustrates a first arrangement example of the second rotation axis 20 and the eyepiece window 142, and FIG. 14B illustrates a second arrangement example of the second rotation axis 20 and the eyepiece window 142.

The first arrangement example may be employed when implementing the display 140 having a linear shape as illustrated in FIGS. 12B and 12C. In the first arrangement example, the second rotation axis 20 is provided to pass through the exit end 144 of the eyepiece optical axis 40. For example, the distance L2 from the second rotation axis 20 to the exit end 144 of the eyepiece optical axis 40 is 0 mm When the second rotation axis 20 is provided as described above, it is possible to implement the alignment adjustment without changing the display position.

The second arrangement example may be employed when implementing the display 140 having a curved shape as illustrated in FIG. 12A. In the second arrangement example, the second rotation axis 20 is provided to pass through a position (between the eye and the eyepiece window 142) situated on the side of the wearer with respect to the exit end 144 of the eyepiece optical axis 40. For example, the distance L2 from the second rotation axis 20 to the exit end 144 of the eyepiece optical axis 40 is 5 mm. When the second rotation axis 20 is provided as described above, the connection position of the display 140 and the connector 130 is situated close to the face, and the display 140 and the connector 130 can be formed to have a shape that follows (extends along) the curved shape of the eyeglass-type frame 150. When the distance L2 from the second rotation axis 20 to the exit end 144 of the eyepiece optical axis 40 is set to 5 mm or less, it is possible to implement the alignment adjustment so that a change in display position occurs to only a small extent.

When implementing the display 140 having a linear shape, the second rotation axis 20 may be provided to pass through a position situated on the side of the wearer with respect to the exit end 144 of the eyepiece optical axis 40 (see the second arrangement example). When implementing the display 140 having a curved shape, the second rotation axis 20 may be provided to pass through the exit end 144 of the eyepiece optical axis 40 (see the first arrangement example).

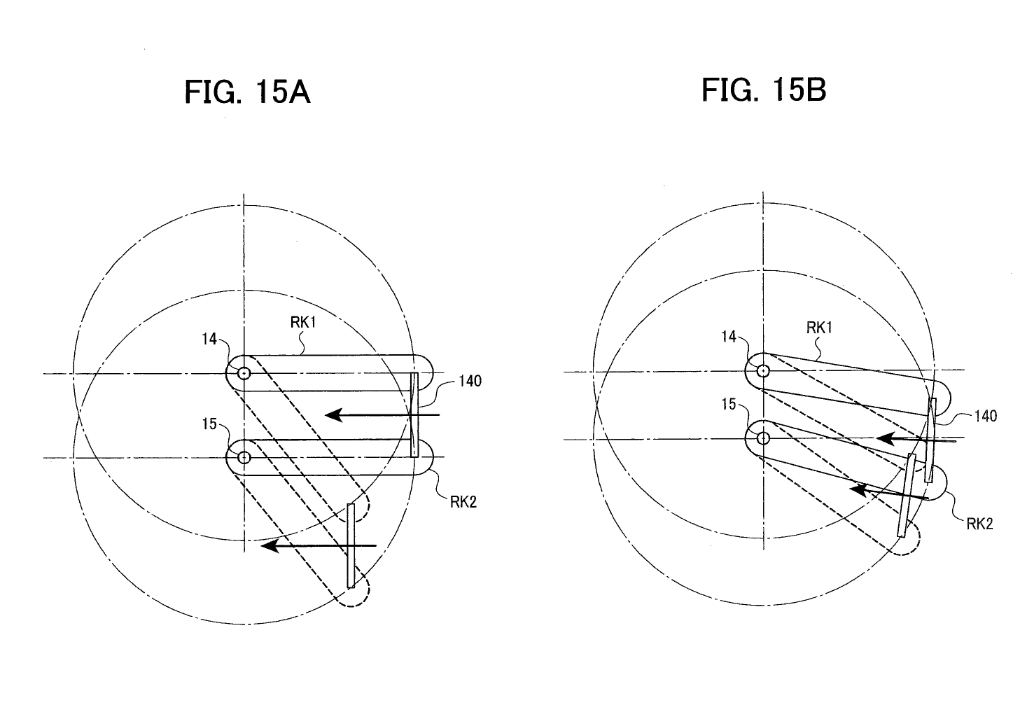

FIGS. 15A and 15B illustrate a modification of the display position adjustment mechanism. Although the above embodiment has been described above taking an example in which the display position is adjusted using one axis (first rotation axis 10), it is also possible to use an adjustment mechanism that utilizes a plurality of axes, or an adjustment mechanism that does not utilize an axis (e.g., flexible mechanism). FIGS. 15A and 15B illustrate an adjustment mechanism that utilizes a link mechanism as an example of such an adjustment mechanism.

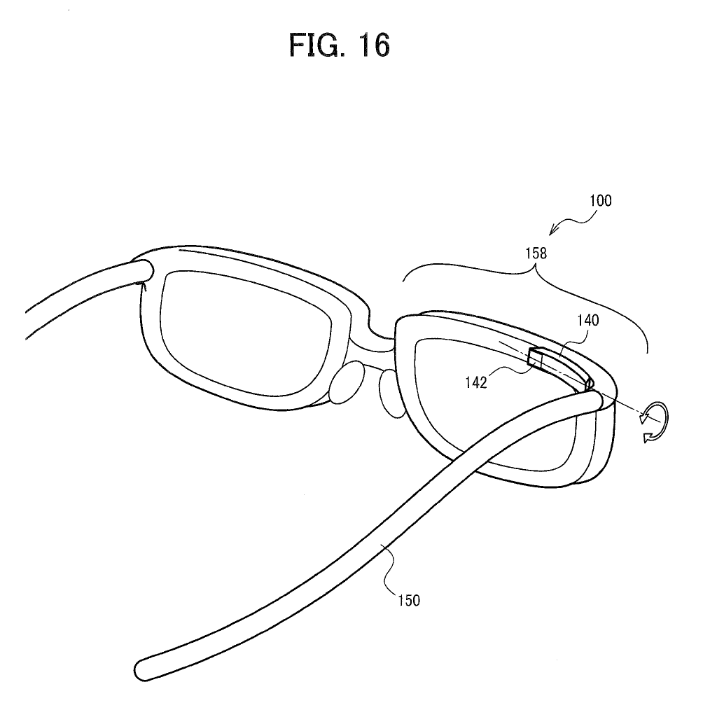

The link mechanism includes two shafts 14 and 15, and each shaft and the display 140 are connected through links RK1 and RK2 (that correspond to the connector 130). FIG. 15A illustrates an example in which the two links RK1 and RK2 are parallel to each other, and FIG. 15B illustrates an example in which the two links RK1 and RK2 are not parallel to each other. When the link mechanism is used, it is possible to cause the display 140 to make a motion along the eyeglass lens instead of a simple circular motion. Specifically, it is possible to keep the display 140 close to the eyeglass lens. When the distance between the two shafts 14 and 15 is shorter than the distance between the links on the side of the display 140 (see FIG. 15B), the optical axis 40 continuously passes through the eyeball center 64 along with the rotation of the link mechanism. When the link mechanism is used, either of the two shafts 14 and 15 (or the center between the two shafts 14 and 15) may be considered to be the first rotation axis 10, or it may be considered that the first rotation axis 10 is implicitly provided (as described later with reference to FIG. 16, for example).

The second rotation axis 20 may be implemented as described below, for example. Specifically, the links RK1 and RK2 may be connected through a third link, the third link and the housing of the display 140 may be connected through a rotation mechanism, and the rotation axis of the rotation mechanism may be used as the second rotation axis 20.

### 3. Second Configuration Example of Wearable Device

FIG. 16 illustrates a second configuration example of the wearable device 100. In the configuration example described above with reference to FIG. 1 and the like, two rotation mechanisms are provided. In the second configuration example, only a rotation mechanism that utilizes the second rotation axis 20 is provided, and the first rotation axis 10 is implicitly present corresponding to individual variations and the wearing state.

The wearable device 100 includes a wearable element that is worn on the head of the wearer, and a display 140 that displays a virtual image within part of the field of view of the wearer. The display 140 is connected to the wearable element so as to be rotatable around a rotation axis (second rotation axis 20) that is orthogonal to a virtual plane 30 that is a plane that includes an eyepiece optical axis 40 of the display 140. The condition “L2≦5 mm” is satisfied when the distance from the intersection of the rotation axis 20 and the virtual plane 30 to an exit end 144 of the eyepiece optical axis 40 is referred to as L2. The eyepiece optical axis 40, the virtual plane 30, the exit end 144, and the distance L are the same as defined above (see FIG. 6).

More specifically, the wearable element is the eyeglass-type frame 150. The display 140 is provided to a rim 158 of the eyeglass-type frame 150. The display 140 may be implemented using a long and narrow optical system (e.g., pupil-division see-through optical system).

The rim 158 is a frame that is provided to the front of the eyeglass-type frame 150, and used to hold a lens. Note that only the frame may be provided without providing a lens.

The display 140 is embedded in the rim 158 on the inner side (side closer to the face) of the rim 158, for example. The display 140 cannot be observed directly from the outer side (front side). The rim and the display 140 are connected through a rotation mechanism (e.g., bearing and shaft). Since the display 140 is embedded in the rim 158, it is preferable that the rotation axis 20 be provided around the center of the long and narrow display 140. For example, the rotation axis 20 passes through the intersection of the reflection plane of a mirror or a prism provided at the exit end, and the eyepiece optical axis (i.e., the center of the cross section of the minor or the prism).

According to the second configuration example, only one rotation axis (rotation axis 20) is used for the adjustment. However, it can be considered that a virtual rotation axis exists around the ear piece of the temple of the eyeglass-type frame 150. The rotation around the virtual rotation axis apparently occurs due to individual variations and the like, and is not intentionally adjusted by the user. The virtual rotation axis is (approximately) parallel to the rightward-leftward direction of the head 70, and the rotation axis 20 is provided (approximately) parallel to the rightward-leftward direction of the head 70. Therefore, the display 140 is provided to the upper part or the lower part of the rim 158 that surrounds the lens.

Note that the display 140 need not necessarily be embedded in the rim 158 of the eyeglass-type frame 150. The second configuration example can be applied as long as only the rotation mechanism that utilizes the second rotation axis 20 is provided, and the condition “L2≦5 mm” is satisfied.

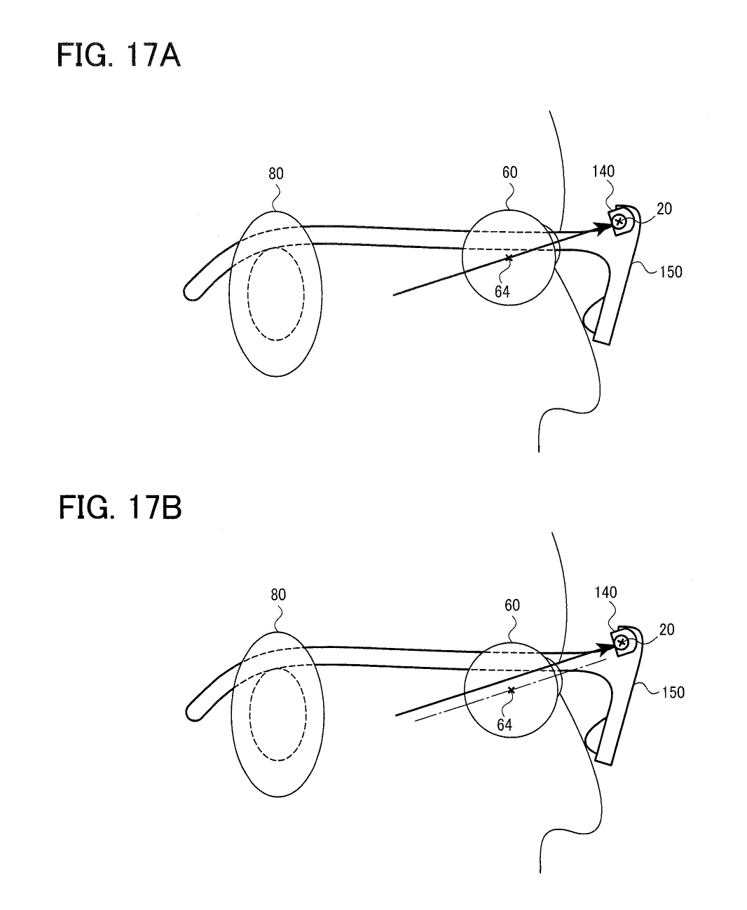

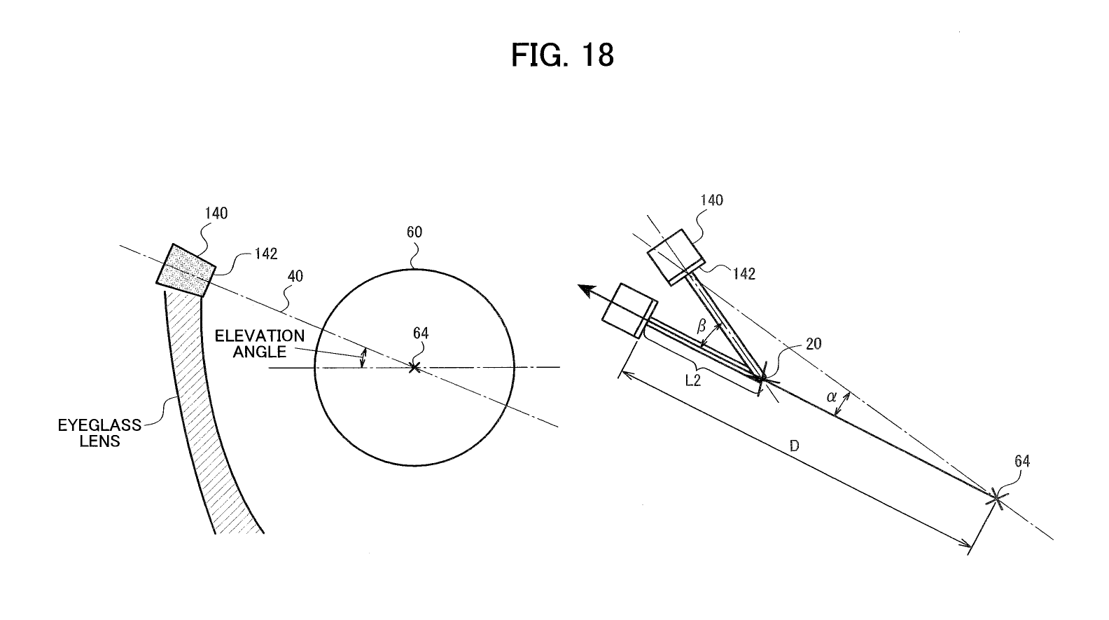

FIGS. 17A to 18 are views illustrating the alignment adjustment according to the second configuration example.

FIGS. 17A and 17B illustrate a state in which different wearers wear an identical wearable device 100. The height of the ear 80 and the position of the eyeball 60 differ depending on the wearer. In the example illustrated in FIG. 17A, the eyepiece optical axis 40 passes through the eyeball center 64 of the wearer. In the example illustrated in FIG. 17B, the eyepiece optical axis 40 does not pass through the eyeball center 64 of the wearer. When the eyepiece optical axis 40 does not pass through the eyeball center 64, it is likely that part of the virtual image cannot be observed, and it is necessary to make the alignment adjustment.

FIG. 18 is a view illustrating the condition (L2≦5 mm) for the distance L2. FIG. 18 illustrates an example in which the wearer makes the alignment adjustment when the wearer has worn the eyeglass-type frame 150. The correction angle around the rotation axis 20 (i.e., a change in angle of a straight line that connects the rotation axis 20 and the exit end of the optical axis) due to the alignment adjustment is referred to as β. A change in elevation angle (i.e., a change in the angle of a straight line that connects the eyeball center and the exit end of the optical axis) due to the alignment adjustment is referred to as α. The distance from the eyeball center to the exit end of the optical axis when the line of sight and the optical axis have been caused to coincide with each other is referred to as D.

As illustrated in FIG. 18, the following expression (4) is satisfied.

tan α=L2×sin β/(D−L2+L2×cos β) (4)

Since the change α in elevation angle and the correction angle β are equal to or less than about 10°, the following expression (5) is approximately satisfied based on the expression (4). Note that the change α in elevation angle and the correction angle β are exaggerated in FIG. 18 for convenience of explanation.

α=L2×β/D (5)

When the display 140 is embedded in the rim 158 of the eyeglass-type frame 150, the distance D is about 25 mm≦D≦about 30 mm. Therefore, when L2≦5 mm, the change ≢0 in elevation angle is about ⅕th of the correction angle β. Specifically, when the correction angle β is approximately equal to the vertical FOV, the change a in elevation angle due to the alignment adjustment is approximately equal to ⅕th of the vertical FOV. Since the vertical FOV of the pupil-division see-through optical system is about 5 to 9°, the change a in elevation angle is about 1 to 1.8°, and a change in display position due to the alignment adjustment occurs to only a small extent.

According to the second configuration example, it is possible to implement a head-mounted display using a simple design that embeds the display 140 in the rim 158 of the eyeglass-type frame 150. Since the display 140 is secured on the rim 158, it is necessary to make the alignment adjustment due to individual variations. However, since the rotation axis 20 is provided so that the condition “L2≦5 mm” is satisfied, it is possible to cause the eyepiece optical axis 40 and the line of sight to coincide with each other through a simple adjustment.

The embodiments to which the invention is applied and the modifications thereof have been described above. Note that the invention is not limited to the above embodiments and the modifications thereof. Various modifications and variations may be made without departing from the scope of the invention. A plurality of elements described in connection with the above embodiments and the modifications thereof may be appropriately combined to implement various configurations. For example, some elements may be omitted from the elements described in connection with the above embodiments and the modifications thereof. Some of the elements described above in connection with different embodiments or modifications thereof may be appropriately combined. Specifically, various modifications and applications are possible without materially departing from the novel teachings and advantages of the invention. Any term cited with a different term having a broader meaning or the same meaning at least once in the specification and the drawings can be replaced by the different term in any place in the specification and the drawings.

What is claimed is:

1. A wearable device comprising:
a wearable element that is worn on a head of a wearer;
a connector that is connected to the wearable element so as to be rotatable around a first rotation axis; and
a display that is connected to the connector so as to be rotatable around a second rotation axis, and displays a virtual image within part of a field of view of the wearer,
wherein a relationship “20 mm≦L1+L2≦45 mm” is satisfied provided that a plane that includes an eyepiece optical axis of the display and intersects the first rotation axis and the second rotation axis is referred to as a virtual plane, a distance from a first intersection that is an intersection of the virtual plane and the first rotation axis to a second intersection that is an intersection of the virtual plane and the second rotation axis is referred to as L1, and a distance from the second intersection to an intersection of an eyepiece and the eyepiece optical axis is referred to as L2.

2. The wearable device as defined in claim 1,
wherein a relationship “L1≧5×L2” is satisfied.

3. The wearable device as defined in claim 1,
wherein a condition “L2≦5 mm” is satisfied.

4. The wearable device as defined in claim 1,
wherein the virtual plane and the first rotation axis are orthogonal to each other, and the virtual plane and the second rotation axis are orthogonal to each other.

5. The wearable device as defined in claim 1,
wherein the virtual plane is parallel to a vertical scan direction of an image that is displayed as the virtual image.

6. The wearable device as defined in claim 1,
wherein the first rotation axis is an axis that passes through an eyeball of the wearer when the wearable element is worn on the head.

7. The wearable device as defined in claim 1,
wherein the first rotation axis is a rotation axis around which the display is rotated to adjust a display position of the virtual image within the field of view, and
the second rotation axis is a rotation axis around which the display is rotated to adjust a direction of the eyepiece optical axis.

8. A wearable device comprising:
a wearable element that is worn on a head of a wearer;
a connector that is connected to the wearable element so as to be rotatable around a first rotation axis; and
a display that is connected to the connector so as to be rotatable around a second rotation axis, and displays a virtual image within part of a field of view of the wearer,
wherein the first rotation axis passes through an eyeball of the wearer when the wearable element is worn on the head, and
a relationship “L1≧5×L2” is satisfied provided that a plane that includes an eyepiece optical axis of the display and intersects the first rotation axis and the second rotation axis is referred to as a virtual plane, a distance from a first intersection that is an intersection of the virtual plane and the first rotation axis to a second intersection that is an intersection of the virtual plane and the second rotation axis is referred to as L1, and a distance from the second intersection to an intersection of an eyepiece and the eyepiece optical axis is referred to as L2.

9. The wearable device as defined in claim 8,
wherein a condition “L2≦5 mm” is satisfied.

10. The wearable device as defined in claim 8,
wherein each of the first rotation axis and the second rotation axis is orthogonal to the virtual plane.

11. A wearable device comprising:
a wearable element that is worn on a head of a wearer; and
a display that displays a virtual image within part of a field of view of the wearer,
wherein the display is connected to the wearable element so as to be rotatable around a rotation axis that is orthogonal to a virtual plane that is a plane that includes an eyepiece optical axis of the display, and
a condition “L2≦5 mm” is satisfied provided that a distance from an intersection of the rotation axis and the virtual plane to an intersection of an eyepiece and the eyepiece optical axis is referred to as L2.

12. The wearable device as defined in claim 11,
wherein the wearable element is an eyeglass-type frame, and
the display is provided to a rim of the eyeglass-type frame.
